(19) United States
(12) Patent Application Publication
(10) Pub. No.: US 2026/0170894 A1
(43) Pub. Date: Jun. 18, 2026

(54) PACKAGING SYSTEM FOR AN ARTICLE INCLUDING AN ELECTRONIC KEY

(71) Applicant: VORTAL

(72) Inventor: Marc Daman, Court-Saint-Etienne (BE)

(73) Assignee: VORTAL, (omitted)

(21) Appl. No.: 19/416,306

(22) Filed: Dec. 11, 2025

(30) Foreign Application Priority Data
Dec. 13, 2024 (BE) 2024/5889

(51) Int. Cl. G07C 9/00; B65D 43/16; B65D 55/14; G21F 5/015; G21F 5/06

(52) U.S. Cl. CPC G07C 9/00817; B65D 43/167; B65D 55/14; G07C 9/00309; G21F 5/015; G21F 5/06; G07C 2009/0042; G07C 2009/00825

(57) ABSTRACT

A system for packaging an item (30) is provided that includes a packaging container (1) configured to contain an item (30) in a cavity (1c) and including a lid (1L) configured to move to a closed position and including an electronic lock (3) comprising an identification number (3ID) r. An electronic key configured to be authorised to unlock an electronic lock (3) according to its identification number. An authorisation device (10) is provide that includes a reader (13ID) configured to read an authorisation code (23ID) sent remotely and associated with one or more identification numbers (3ID) of electronic locks (3), the device being configured to change an electronic key to authorised key status (12a), authorising it to unlock the electronic locks (3) whose identification numbers (3ID) are included in the authorisation code (23ID).

### RELATED APPLICATIONS

This application is a Paris Convention filing that claims priority of BE2024/5889, filed Dec. 13, 2024; the contents of which are incorporated herein by reference.

### FIELD OF THE INVENTION

The present invention relates to a packaging system that allows a sender to lock an item in a packaging container, send it to a recipient, and only allow the recipient to unlock the packaging container to access the item once an authorisation code has been communicated remotely by the sender or a third party. The present invention allows an item stored at the recipient's premises to be kept confidential, without the recipient being able to access it until a predefined criterion is met.

### BACKGROUND OF THE INVENTION

When a sender sends a package to a recipient, the sender generally has little control over what happens to the package, who will open it, when it will be opened, etc. To ensure that only authorised persons can open the package, U.S. Pat. No. 10,867,457 proposes an electronic control system for opening a container locked by an electronic lock, using, for example, a smartphone to scan and compare a package ID on the one hand and a recipient ID badge on the other. If the recipient is authorised to open the container, the electronic lock opens automatically, giving the recipient access to its contents.

Following the same logic as in U.S. Pat. No. 10,867,457 of only allowing a package to be opened once the recipient has been identified as authorised, U.S. Pat. No. 10,097,353 describes a system comprising a user device that stores a private electronic key corresponding to a user profile. When a product order is associated with the user profile, a public key paired with the private key is encoded on a storage medium in the package. When the package is brought close to the user device, the device sends a wireless signal that automatically unlocks the package if the public key encoded on the storage medium matches the private key stored on the user device. These two examples ensure that the package is opened by its intended recipient and not by an unauthorised third party.

However, there are situations where an item must be shipped to a recipient, but the recipient is only allowed to access the item after receiving authorisation, even if the item is stored at the recipient's location. For example, radioisotopes are used in medicine for diagnostic treatments as markers and, in some cases, for therapeutic treatments. Some of these radioisotopes have half-lives of only a few minutes to a few hours. Table 1 lists examples of radioisotopes used in medicine and their half-lives. The half-life of a radioisotope defines the time required for the population of the radioisotope to decrease by half. FIG. 6 graphically illustrates the geometric decrease in the population, P, of a radioisotope as a function of time expressed in half-life units, t/tR, where tR is the half-life of the radioisotope, according to the equation, P(t/tR)=exp(ln(2) t/TR)). For example, with a half-life of 20 min, an initial population of radioisotope ¹³C would be reduced in 1 hour to 13% of the initial population (see P(t/tR) in FIG. 6 at t/tR=60/20=3). Once produced, radioisotopes must therefore be shipped as quickly as possible so that the recipient receives a sufficient population of radioisotopes for their application.

TABLE 1
Examples of radioisotopes used in medical
applications, along with their half-lives

| | Radioisotope | | | | | | |
|---|---|---|---|---|---|---|---|
| | ¹⁵O | ¹³N | ¹¹C | ⁶⁸Ga | ¹⁸F | ^{99m}Tc | ¹²³I |
| Half-life, | 2 min | 10 min | 20 min | 68 min | 110 min | 6 hours | 13.2 |
| tR | | | | | | | hours |

Since radioisotopes are most often injected into the body, it is important to ensure their quality. Radioisotopes must therefore meet pre-established quality criteria before they can be used by the recipient (usually a clinic). However, testing to determine whether radioisotopes meet the criteria takes some time. Depending on the half-life of the radioisotope, it is better to ship the radioisotope to the recipient before the test results are available and notify the recipient that they can use the radioisotope once the test results are available and positive in order to shorten the time between production and use of the radioisotope. This usually goes well, but there may be cases where a clinician, unable to keep their patient waiting any longer and aware of the rapid decline in the isotope population, injects it into the patient before receiving the green light. This situation, fortunately very rare, is unacceptable because it puts the patient at great risk if the isotope does not meet the quality criteria.

Another example is the distribution to different examination centres of questions for a centralised examination to be held at a later date. For example, questions for a baccalaureate examination are distributed to all examination centres in a department several days before the date of the examination. Leaks sometimes occur and the questions are fraudulently made available to candidates. Another example is ballot containers, which can also be subject to fraud during their journey between polling stations and counting stations.

To solve this problem, one could imagine that both the sender and the recipient have a key to lock and unlock the container containing the item. However, this solution is unsatisfactory because the sender would need to have as many keys as there are containers and would have to ensure that the same recipient always receives the same container that can be unlocked with the key in their possession. Furthermore, this does not prevent the recipient from accessing the item before receiving authorisation to do so.

Radio frequency identification (RFID) tags can be used to identify packaging crates, but they do not allow the sender to authorise or deny unlocking. One option is to use a lock on the crate with an alphanumeric code that unlocks the lock, and only send the alphanumeric code once the recipient has been authorised to access the item. However, this solution becomes very inconvenient when the recipient receives several packaging crates, each with its own alphanumeric code that must be entered without mistaking the crate or the code.

One could also imagine a lock programmed to unlock at a given time, but this solution would only be suitable for situations where the container cannot be opened before a given time and not for cases where authorisation can be given at different times according to different criteria (e.g., the positive result of item quality criteria). In addition, a lock equipped with a timer consumes energy and therefore requires monitoring to ensure that the batteries are always sufficiently charged.

To date, there is no satisfactory solution to this relatively simple problem of delayed and remote authorisation for unlocking a packaging container. The present invention provides a packaging system comprising a packaging container adapted to enclose an item and equipped with a locked lock that can only be unlocked with an authorised key, which is by default not authorised to unlock this lock. The present invention and its advantages are described in more detail in the following sections.

### SUMMARY OF THE INVENTION

The present invention is described in the accompanying independent claims. Preferred embodiments are defined in the dependent claims. In particular, the present invention relates to a system for packaging an item comprising:
A packaging container configured to contain an item in a cavity and comprising a lid configured to move between an open position providing access to the cavity and a closed position preventing access to the cavity, the packaging container being equipped with an electronic lock comprising an identification number and configured to lock the lid in the closed position and to allow it to be unlocked only by means of an electronic key authorised to unlock it,
The electronic key is by default in a status that is not authorised to unlock any electronic lock and is configured to switch
   from the default unauthorised key status, in which the unauthorised key cannot unlock the electronic locks,
   to an authorised key status, in which the authorised key is able to unlock the electronic locks for which it has received authorisation based on the identification number.
An authorisation device comprising a reader configured to read an authorisation code associated with one or more identification numbers of electronic locks, the device being configured to change a status of an electronic key from the status of unauthorised key to the status of authorised key authorising the authorised electronic key to unlock one or more electronic locks whose identification number(s) are included in the authorisation code.
A release centre configured to generate and remotely send the authorisation code comprising a list of one or more packaging containers to a recipient in possession of the one or more packaging containers, the authorisation device and the electronic key, only after predefined criteria have been met, which are independent of the recipient(s) and necessary for authorising the opening of the one or more packaging containers by the authorised electronic key.

The authorisation code may be a QR code or a barcode or an alphanumeric code, and the reader (13ID) is a QR code or barcode reader or an interface for entering the alphanumeric code.

In a preferred variant of the invention, the packaging system is adapted for transporting the article consisting of a radioisotope having a half-life preferably less than 24 hours, the packaging system comprising:
a vial configured to enclose the radioisotope; and
a shielded container configured to enclose the vial containing the radioisotope and to be enclosed within the cavity of the packaging case.
   This packaging system preferably defines a Type A package.

The present invention also relates to a method for preventing the opening of a packaging container containing an item without prior authorisation, which is granted according to predefined criteria. The method comprises the use of a packaging system as defined above in the following manner.
(A) a sender packs each item in a packaging container and locks the electronic lock with the lid in the closed position,
(B) the packaging containers are delivered to one or more recipients, each recipient having an authorisation device and at least one unauthorised electronic key,
(C) as long as predefined criteria independent of the recipient(s) and necessary for authorising the opening of one or more packaging containers are not met, the corresponding electronic key(s) (3) remain in the unauthorised key status and the packaging container(es) (1) cannot be opened by the corresponding recipient(s),
(D) once the predefined criteria are met, the release centre (100) generates an authorisation code comprising the identification numbers of the electronic locks of the containers sent to each recipient and sends them to the corresponding recipients,
(E) using their device, each recipient changes the status of their electronic key from unauthorised key to authorised key for the electronic locks that correspond to them and that are contained in the authorisation code they have received, and
(F) each recipient can unlock the electronic lock on the packaging crates they have received using their authorised key and can access the item that meets the predefined criteria.

In a preferred variant, if the predefined criteria are not met, the sender or third party does not send the authorisation code and informs each recipient that the corresponding packaging crates will be taken back by the sender or third party.

This method is particularly suitable in cases where the item is a radioisotope with a half-life preferably less than 24 hours. The method then comprises the following steps.
A producer produces the radioisotope and encloses it in vials. The vial is preferably enclosed in a shielded container, thus preferably forming a Type A package.
The producer analyses the radioisotope produced to determine whether it complies with the radioisotope quality criteria defining the predefined criteria.
The shipper packs each vial, preferably contained in the shielded container, in a packaging crate and locks the electronic lock with the lid in the closed position.
The packaging cases are delivered to one or more recipients, each of whom has an authorisation device and at least one unauthorised electronic key.
the recipient(s) store the packaging cases, which cannot be opened without the corresponding authorisation codes that allow the unauthorised keys to be changed to authorised keys that can open them,
once the radioisotope analyses have been completed and the radioisotope is considered to comply with the predefined quality criteria, the producer generates an authorisation code comprising the identification numbers of the electronic locks (3) of the containers sent to each recipient and sends them to the corresponding recipients,
using their authorisation device, each recipient changes the status of their electronic key from unauthorised to authorised for the electronic locks that correspond to them and are contained in the authorisation code they have received, and
each recipient can unlock the packaging containers they have received with the authorised key and can access the radioisotope (which is certified as complying with quality criteria).

In the case of radioisotopes, the time (tB) required to complete the radioisotope analyses and determine whether the radioisotope complies with the radioisotope quality criteria is preferably
longer than the time tC required to package the radioisotope (step C) (i.e., tB>tC) and
preferably longer than the time (tC+tD) required to package the radioisotope (step C) and deliver it to one or more recipients (step D) (i.e. tB>(tC+tD)), leaving the packaging crates locked at one or more recipients for a period of time (tE=tB−(tC+tD)), until the authorisation code is received.

It is also preferred that the time (tB) required to complete the radioisotope analyses and determine whether the radioisotope meets the radioisotope quality criteria be less than two half-lives, tR, of the radioisotope, preferably less than one half-life, tR, of the radioisotope (i.e., tB<2tR, preferably tB<tR). For example, the half-life of the radioisotope may not exceed more than 14 hours; preferably no more than 6 hours, and even less than 2 hours. Examples of radioisotopes according to these criteria include ¹³N with a half-life of 10 minutes, or ¹¹C with a half-life of 20 min, ⁶⁸Ga with a half-life of 68 min, or ¹⁸F with a half-life of 110 min, or ^{99m}Tc with a half-life of 6 hours, or ¹²³I with a half-life of 13.2 hours.

The method of the present invention may be implemented in other applications, such as, for example,
The item is delivered to one or more recipients prior to payment for the item, and the predefined criteria include receipt of payment for the item, or
The item is a chemical product and the predefined criteria include compliance with quality criteria requiring analysis, or
The item is a chemical product or a medicine whose use is subject to prior approval by a superior who is located far from the storage location of the package, or
The item can only be accessed on a predefined date after the date of receipt, preferably the date is predefined by contract or by law.

In a preferred variant of the invention, once authorised, the authorised electronic key automatically becomes unauthorised again after a predetermined time or after the corresponding electronic lock has been unlocked.

### BRIEF DESCRIPTION OF THE FIGURES

Various aspects of the present invention are illustrated in the following Figures.

FIGS. 1a to 1c: illustrate an example of a packaging system according to the invention configured to contain a radioisotope in a sequence of packaging the article, (a) lid open and article outside the cavity, (b) insertion of the article into the cavity, and (c) closure of the lid locked by the electronic lock.

FIG. 2a: illustrates an unauthorised electronic key.

FIGS. 2b and 2c: illustrate (b) an authorisation device comprising a reader and (c) authorisation of the electronic key by coupling it to the authorisation device and reading a QR code by the reader defining the electronic locks that the electronic key will be authorised to open.

FIGS. 3a to 3c: illustrate the example packaging system of FIGS. 1a to 1c, containing a radioisotope in the cavity that is locked, in a sequence of unpacking the item (a) unlocking the electronic lock with the electronic key authorised to open it, (b) opening the lid and removing the item, and (c) the item is available to the recipient and the electronic key automatically deactivates after a certain period of time or after the electronic lock is unlocked.

FIG. 4a: illustrates on a timeline the various stages involved in delivering a radioisotope between its production and its availability to a recipient.

FIG. 4b: presents a flowchart illustrating the stages of transfer and delivery of a radioisotope to a recipient according to the invention.

FIG. 5a: illustrates on a timeline the various stages involved in delivering an item between its production and its availability to a recipient, where the predefined criterion is a date.

FIG. 5b: presents a flowchart illustrating the stages of transfer and delivery of an item according to FIG. 5a to a recipient according to the invention.

FIG. 6: presents a graph illustrating the degradation of a radioisotope as a function of time measured in units of the radioisotope's half-life (=t/tR).

### DETAILED DESCRIPTION OF THE INVENTION

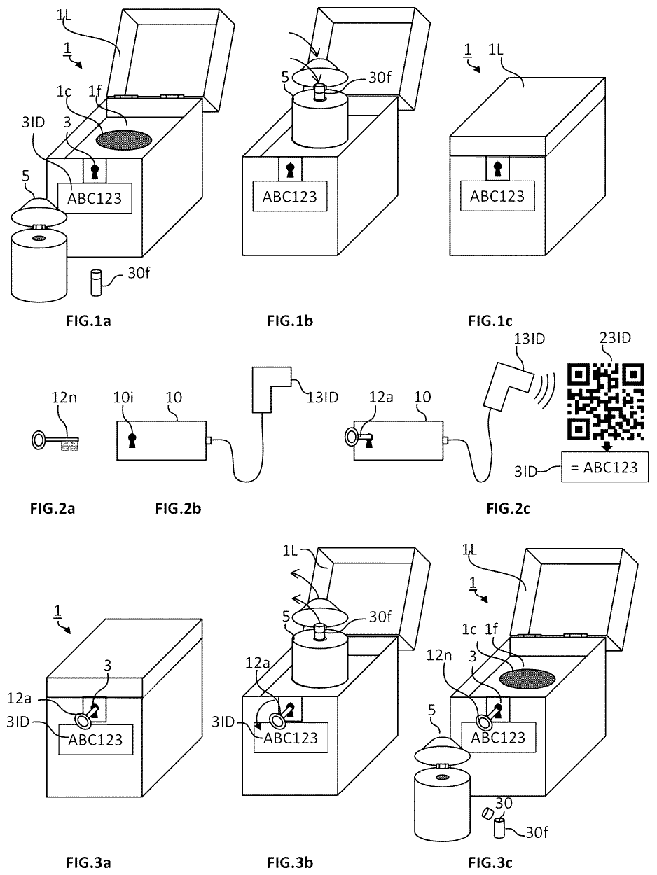

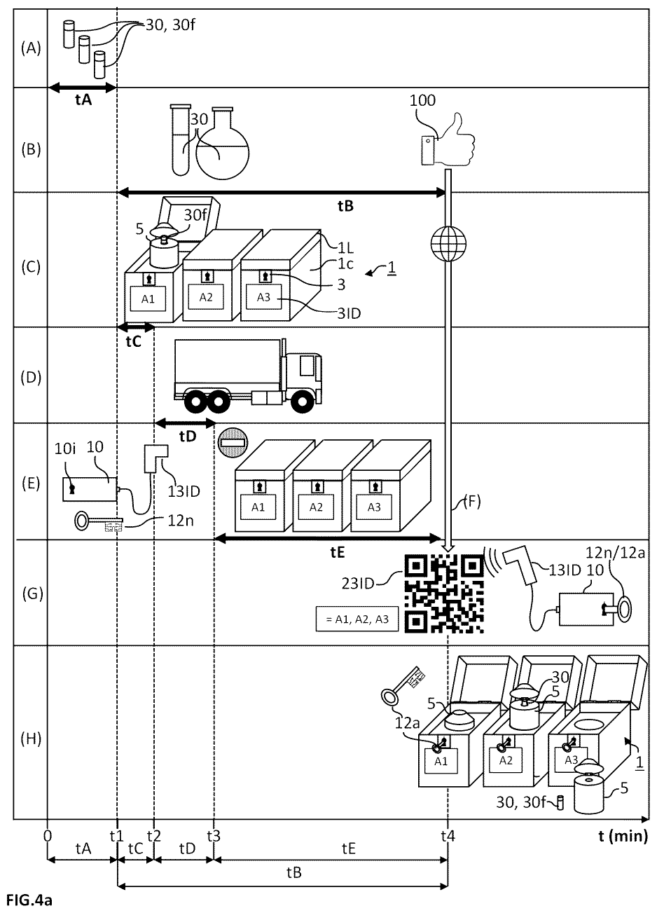

FIGS. 1a to 1c, 2a and 2b illustrate the various components forming the packaging system of the present invention, which comprises
a packaging case (1) equipped with an electronic lock (3),
a physical electronic key (12n) configured to be inserted into the electronic lock but which is by default unauthorised to unlock the electronic lock (3), and
an authorisation device (10) configured to authorise the electronic key to unlock the lock on the packaging case using an authorisation code (23ID), and
a release centre (100) configured to generate and remotely send the authorisation code (23ID).

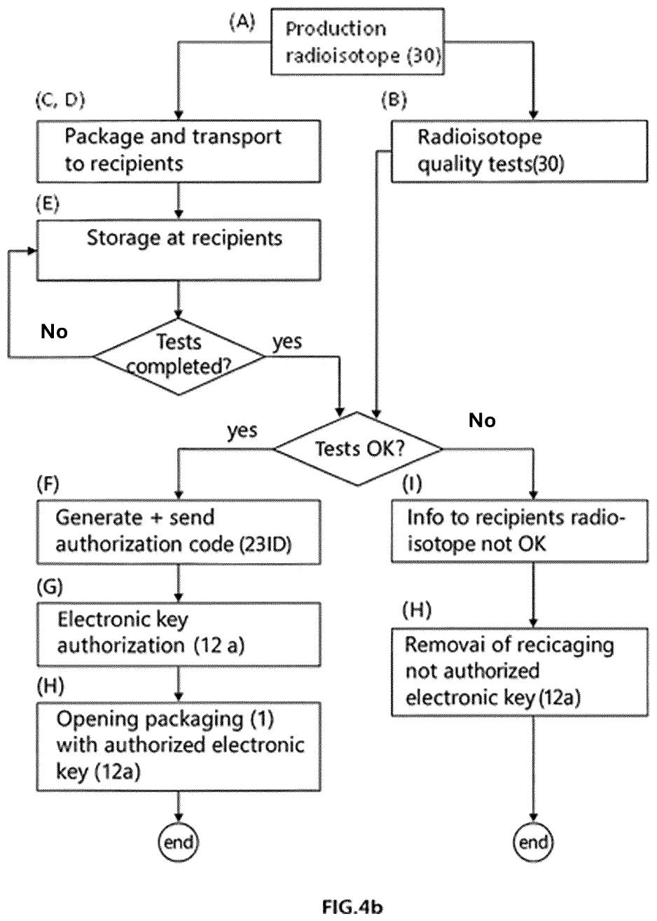

As illustrated in FIGS. 1a to 1c and 3a to 3c, the packaging container (1) is configured to contain an item (30) in a cavity (1c). It comprises a lid (1L) configured to pass between an open position giving access to the cavity (1c) and a closed position preventing access to the cavity. The packaging container is equipped with an electronic lock (3) comprising an identification number (3ID). The electronic lock (3) is configured to lock the lid in the closed position and to allow it to be unlocked only with an authorised electronic key (12a).

By default, the electronic key (3) is in a status that does not authorise it to unlock any electronic lock (3). However, it is configured to switch
from the default unauthorised key status (12n), in which the unauthorised key cannot unlock the electronic locks
to an authorised key status (12a) in which the authorised key (12a) is able to unlock the electronic locks (3) for which it has received authorisation according to the identification number (3ID).

The authorisation device (10) comprises a reader (13ID) configured to read an authorisation code (23ID) associated with one or more identification numbers (3ID) of electronic locks (3). The device is configured to change the status of an electronic key from unauthorised key status (12n) to authorised key status (12a), allowing the authorised electronic key (12a) to unlock one or more electronic locks (3) whose identification number(s) (3ID) are included in the authorisation code (23ID).

The physical electronic key (3) and the authorisation device (10) are in the possession of the recipient of the item. However, even if they are in possession of the packaging container, the recipient cannot unlock the electronic lock (3) with their electronic key, which is unauthorised by default, until they receive the authorisation code (23ID) sent by the release centre (100), which allows them to change their electronic key to authorised key status (12a) to unlock the electronic lock (3) corresponding to the identification number (3ID) indicated in the authorisation code (23ID). The same key may be authorised to unlock the locks of several packaging containers according to a list of identification numbers (3ID) contained in the authorisation code (23ID).

### The Item (30)

The item (30) may be of any nature, solid, liquid or gaseous, as long as it can be contained in the cavity of a packaging container. The item may be contained in a container which is itself placed in the cavity of the packaging container. This applies especially (but not only) to liquid and gaseous items. For example, FIGS. 1a and 3c show an article (30) contained in a vial (30f) which is itself placed in a container (5) which is placed in the cavity as illustrated in FIGS. 1b and 3b.

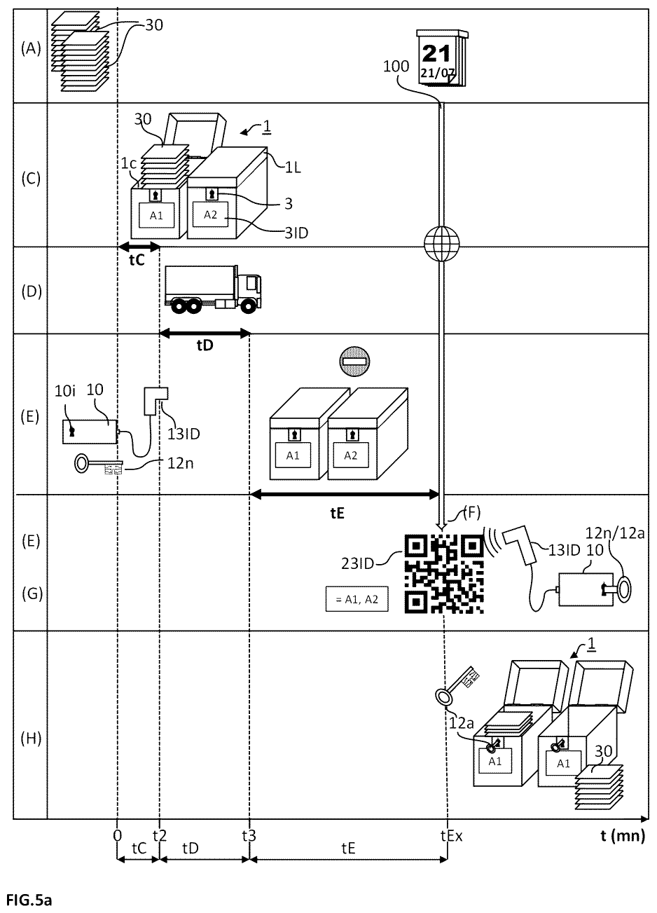

In a preferred embodiment of the invention, the article (30) is a radioisotope characterised by its half-life. As discussed above, radioisotopes for medical use must successfully pass quality tests before being injected into a patient's body. As illustrated in FIG. 4a, since quality tests take a certain amount of time, tB, radioisotopes cannot be used before time tB, which is incompressible. If we wait for the results of the quality tests before sending the radioisotopes, the recipient would not receive them until time (tB+tD), where tD is the time it takes to transport the item to the recipient. The packaging time, tC, is not taken into account, as the item can be packaged during the testing time, tB, before the quality test results are available. It may be tempting for a recipient to open the packaging case before the tests are complete and inject a radioisotope into a patient's body without being certain that the radioisotope meets the quality criteria. The present invention makes it possible to prevent this temptation, since the recipient will only be able to unlock the packaging container of the present invention once they have received the authorisation code (23ID) sent by the sender or an authorised third party, which authorises the electronic key to open one or more packaging containers (1) identified by their identification number (3ID).

Due to the exponential reduction in the radioisotope population over time, it is important to reduce the ratio between the time required for the recipient to access the item (30) once it has been produced and the half-life, tR, of the radioisotope. If we wait for the time tB to receive the quality test results before shipping the radioisotope, this ratio becomes (tB+tD)/tR. If, on the other hand, we package and ship the radioisotope to its recipient while the tests are in progress and before receiving the results, this ratio is reduced to tB/tR. For this reason, it is customary to ship radioisotopes before obtaining the results of quality tests so that the recipient can use them tB time after their production, as soon as the results of the quality tests are available (and positive).

The present invention is particularly suitable for the transport of radioisotopes with a half-life preferably less than 24 hours, such as, for example, the radioisotopes listed in Table 1, ¹⁵O, ¹³N, ¹¹C, ⁶⁸Ga¹⁸F, ^{99m}Tc, ¹²³I.

In general, radioisotopes with a half-life of less than 30 minutes are preferably produced at the place of use and are not shipped, as the isotope population would be reduced too drastically during the time required for delivery. This applies, for example, to ¹⁵O, ¹³N and ¹¹C, which have half-lives of 2, 10 and 20 minutes, respectively. Even in this case, the packaging system of the present invention would be suitable because the laboratory of a clinic producing the radioisotopes (=sender) can transfer them to the department of the same clinic (=recipient) that will need them, but which will only have access to them once the quality tests have been completed and are positive.

By prohibiting the unlocking of packaging containers (1) containing radioisotopes before the authorisation code (23ID) is sent, it is ensured that no one will use the radioisotopes before the quality tests have been completed with positive results.

By extension, items (30) can be chemicals or foodstuffs with limited shelf life that are subject to quality testing before use or consumption. Items can be documents that must remain confidential until a certain date, such as exam questions that must remain confidential until the day of the exam. The item (30) may also include ballot papers in a sealed ballot container that must remain confidential until the time and place when the counting of votes is to commence. Alternatively, the items may be items sold by mail order and only allowing access to the item once payment has been received.

### Packaging Container (1)

The packaging container (1) may be of any size and shape suitable for containing the item (30). It must include a cavity (1c) capable of receiving the item (30) and a lid (1L) configured to move between an open position giving access to the cavity (1c) and a closed position preventing access to the cavity (1c). The packaging container is also equipped with an electronic lock (3) configured to lock the lid in the closed position. The electronic lock is associated with an identification number (3ID) and can only be unlocked using an authorised electronic key (12a). With the exception of the lock, which must be an electronic lock (3), the packaging container (1) of the present invention is similar to any packaging container that allows the lid (1L) to be locked in the closed position. The lid (1L) preferably remains attached to the packaging container even when open. For example, the lid may be coupled to the rest of the packaging container by hinges.

Depending on the type of item (30) it is intended to contain, the packaging container may be constructed from any material that meets the requirements for transport and prevents access to the item it contains by anyone who does not have an authorised electronic key (12a) to unlock it. For example, the packaging case may be made of wood, such as plywood, metal, such as aluminium or steel, ceramic, such as glass, or thermoplastic polymer material, such as PE, PP, PET, PA, or thermosetting polymer material, such as epoxy or polyester. The polymer materials are preferably reinforced with short or long reinforcement fibres, for example glass, carbon, aramid or plant fibres. To increase mechanical impact resistance, the corners of the packaging container can be reinforced with harder materials or, conversely, shock-absorbing materials that absorb some of the energy caused by impacts.

The cavity (1c) may be filled with a cushioning material that is less rigid than the material forming the packaging container (1). For example, the cushioning material may be foam chips or a monolithic structure filling a portion of the cavity (1c). Preferably, the cavity comprises a monolithic foam (1f) cut to fit the geometry of the article (30) or an intermediate container (5) containing the article (30). For example, as illustrated in FIGS. 1a, 1b, 3b and 3c, the packaging container may be intended for the transport of radioisotopes. The radioisotope may be enclosed in a vial (30f). In order to contain the radioactive radiation from the radioisotope, the vial (30f) containing the radioisotope may be enclosed in a shielded container (5) configured to absorb at least some of the radiation. The packaging case ( ) preferably comprises foam (1f) inserted into the cavity (1c) and comprising a cut-out matching the geometry of the shielded container (5) in order to stabilise it in the cavity (1c). With the shielded container (5), the packaging case (1) preferably defines a Type A package as defined in IAEA Safety Standards, “Regulations for the Safe Transport of Radioactive Material,” 2018, Specific Safety Requirements No. SSR-6 (Rev. 1), available on the web page, https://www-pub.iaea.org/MTCD/Publications/PDF/PUB1798_web.pdf.

It is preferred that the packaging crate includes one or more handles for transporting it. In a first variant of the invention, the packaging crate may include two handles placed on two opposite side faces of the crate, allowing heavy packaging crates (1) to be carried with two hands. In a preferred variant, the packaging container (1) includes a handle allowing it to be carried by one person using only one hand. For example, the handle may be located in the middle of the upper side of the lid (1L). This variant is particularly advantageous for transporting radioisotopes, because by carrying the packaging container (1) with one hand at the side of the body, the radioisotope is further away from organs sensitive to radiation (e.g., genitals, digestive system, liver, etc.) than when carrying the packaging container in front of oneself with both hands as in the first variant, which considerably reduces the exposure of these organs to radiation, the intensity of which decreases rapidly with distance.

### Electronic Lock and Key (3, 12a, 12n)

Electronic keys and locks, sometimes referred to as digital keys and locks, are well known and commercially available. These are physical electronic keys that are inserted into the electronic lock and manipulated to unlock the lock. For example, many cars now have electronic keys. Companies such as Assa Abbloy, Makekeylock, and Salto offer ranges of programmable electronic keys and locks that can be used in the present invention.

Each electronic lock (3) is identified by a unique identification number (3ID) known to the sender. The sender therefore knows at all times which packaging crates, identified by the identification number (3ID) of their electronic lock (3), are located at each recipient's premises. The electronic lock preferably locks automatically simply by bringing the lid (1L) into the closed position. The electronic keys are unauthorised by default (12n), i.e. by default they cannot open any electronic locks (3).

Each recipient has one or more electronic keys (12n) and an authorisation device (10). As illustrated in FIGS. 2b and 2c, the authorisation device (10) includes an interface (10i) for communicating with the electronic key (12n). The authorisation device (10) also comprises an authorisation code reader (10L). The authorisation code (23ID) comprises the identification numbers (3ID) of the electronic locks (3) that the electronic key will be authorised to unlock. The authorisation device is configured to programme the electronic key (12n) through the interface (10i) so as to change it from the default unauthorised key status (12n) to the authorised key status (12a) to unlock the electronic locks (3) whose identification number (3ID) has been read by the reader (10L). For example, as shown schematically in FIGS. 2a and 2c, the initially unauthorised key (12n) changes to authorised key status (12a) via the interface (10i) after reading the QR code comprising the identification number (3ID) “ABC123” of the corresponding electronic lock, which can now be unlocked by the authorised electronic key (12a).

As illustrated in FIG. 3a, the electronic lock with identification number (3ID)= “ABC123” can be unlocked by the authorised key (12a). FIG. 3b shows that the cover can then move to the open position and give access to the cavity (1c) and the item (30) it contains, possibly contained in an intermediate container (5), such as a shielded container in the case where the item is radioactive. Until the recipient receives the authorisation code (23ID), the electronic key (12n) in their possession remains, by default, unauthorised to open any electronic lock.

### Authorisation Machine (10)

Each recipient has an authorisation device (10). In some cases, the sender may have an authorisation device (10) delivered with the packaging container, which is returned to the sender by the delivery service. The key point is that the recipient must be in possession of an authorisation machine (10) at the time when the predefined conditions are met and the authorisation code is sent to the recipient.

As illustrated in FIGS. 2b and 2c, the authorisation device (10) includes an interface (10i) for communicating with the electronic key (12n). The authorisation device (10) also includes an authorisation code reader (10L). The authorisation code (23ID) comprises the identification numbers (3ID) of the electronic locks (3) that the electronic key will be authorised to unlock. The authorisation code (23ID) may be a QR code, a barcode or simply an alphanumeric code. In these cases, the reader (10L) of the authorisation machine (10) is a QR code, barcode or alphanumeric code reader. The authorisation device is configured to program the electronic key (12n) through the interface (10i) so as to change it from the default status of unauthorised key (12n) to the status of authorised key (12a) to unlock the electronic locks (3) whose identification number (3ID) has been read by the reader (10L). For example, as shown schematically in FIGS. 2a and 2c, the initially unauthorised key (12n) changes to authorised key status (12a) via the interface (10i) after reading the QR code containing the identification number (3ID) “ABC123” of the corresponding electronic lock, which can now be unlocked by the authorised electronic key (12a).

The electronic key authorisation system (3) by the authorisation machine (10) according to the present invention differs from prior art authorisation systems in which authorisation is performed directly via the internet using a driver installed on the recipient's computer. Authorisation via the internet poses cybersecurity problems because a computer connected to the internet is vulnerable. In addition, there may be internet outages that would render such an authorisation system inoperable. The authorisation machine (10) of the present invention allows electronic keys to be authorised via a code. Regardless of the type of code used (QR, barcode or alphanumeric), it can be sent to a mobile phone screen via messaging, optionally subject to electronic signature verification (e.g. ITSME®), by fax or email or other messaging to a secure computer belonging to the recipient, where it can simply be printed out. An alphanumeric code can even be communicated verbally by telephone. Thus, with the authorisation system of the present invention, it is not necessary to install a driver at the recipient's premises and the recipient does not necessarily have to be connected to the internet to authorise an electronic key, which means that the cybersecurity of the recipient's computer system is not affected.

The authorisation machine (10) preferably includes a memory for local storage of all operations performed with the keys. This is particularly important, for example, in cases where the recipient is a hospital or clinic and the item (30) is a radioisotope, in order to ensure the traceability of products injected into patients.

### Method for Controlling Authorisation to Unlock an Electronic Lock

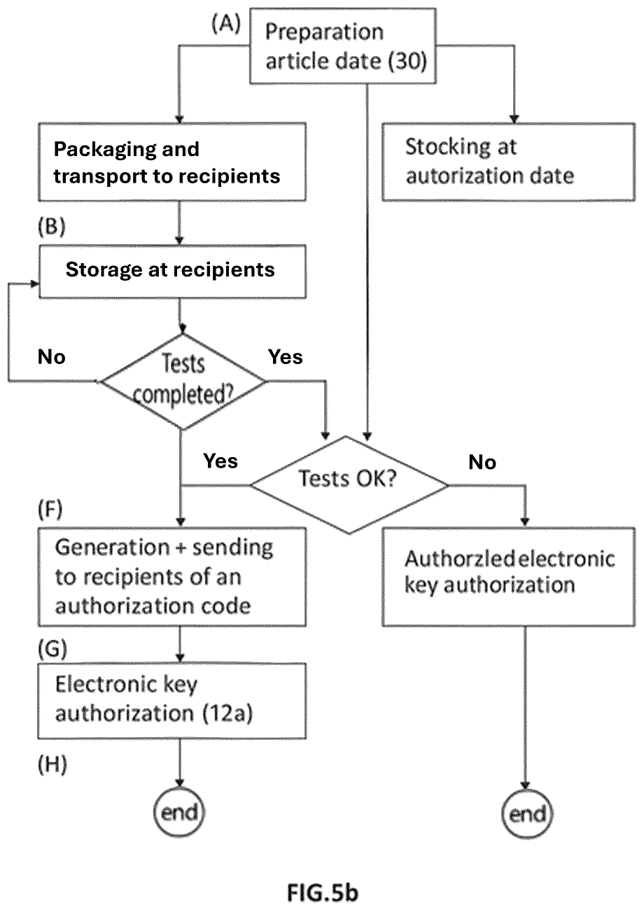

The present invention also relates to a method for preventing the opening of a package (1) containing an article (30) without prior authorisation, which is granted according to predefined criteria. The method comprises the use of a packaging system as described above. As illustrated in step (C) of FIGS. 4a, 4b, 5a and 5b, the item (30) is first packaged in a packaging container (1) and the electronic lock (3) is locked with the lid (1c) in the closed position. As the packaging container will in most cases be shipped to an external recipient, the entity that produced the item (30), this operation is completed by a shipper. The shipper may be an internal department of the entity that produced the item (30) or a shipping company (e.g., post office, distribution service, courier).

The packaging containers (1) are delivered to one or more recipients. Each recipient has at least one unauthorised electronic key (12n) and an authorisation device (10) configured to authorise an electronic key (12a) to unlock one or more packaging containers (1) upon reading the authorisation code (23ID) according to the identification number (3ID) of their respective electronic locks (3) contained in the authorisation code.

While waiting for the corresponding authorisation codes, the recipient(s) store the packaging crates (1), which cannot be opened without the corresponding authorisation codes that change the keys from unauthorised status (12n) to authorised status (12a), allowing them to be opened. Once the opening of the packaging containers can be authorised according to predefined criteria, the sender or an authorised third party generates, via an authorisation station (100) such as a computer, smartphone, etc., an authorisation code (23ID) comprising the identification numbers (3ID) of the electronic locks (3) of the containers sent to each recipient and sends the to the corresponding recipients. Each identification number (3ID) corresponds to a unique electronic lock (3) of a unique packaging container (1). The sender or authorised third party knows the identification numbers (3ID) corresponding to the crate(s) shipped to each recipient and can thus send a personalised authorisation code (23ID) to each recipient comprising the corresponding identification numbers (23ID). The authorisation codes (23ID) containing the identification numbers (3ID) of the electronic locks (3) of the containers sent to each recipient can be sent to the corresponding recipients by email, or via personalised access to an internet platform where the authorisation code has been entered, or via a WAP protocol, including messaging, SMS or MMS.

Using their authorisation device (10), each recipient changes the status of their electronic key from unauthorised key (12n) to authorised key (12a) for the electronic locks that correspond to them and are contained in the authorisation code (23ID) they have received. The reader (10L) reads the identification numbers (3ID) of the electronic locks (3) concerned and automatically limits the authorisation of the electronic key to these electronic locks only, without any risk of human error in transcription or encoding. Once the electronic key has been authorised (12a) to unlock the packaging crates in its possession, each recipient can unlock the electronic lock on the packaging containers (1) they have received using their authorised key (12a) and can access the item (30) that meets the predefined criteria. Preferably, the authorised electronic key (12a) automatically becomes unauthorised (12n) again after a predetermined time or after the corresponding electronic lock has been unlocked.

This process is simple and reliable and has several advantages. On the one hand, each electronic lock (3) is identified by its unique identification number (3ID). This means that the same packaging container (3) does not necessarily have to be associated with the same recipient. On the other hand, the electronic locks are passive and do not consume energy. This means that the packaging crates (1) can be reused as many times as necessary without any maintenance other than ensuring their physical integrity and hygiene (sterilisation if necessary), without having to monitor the battery charge status. Finally, even if the packaging container(es) (1) are stored at the various recipients' premises for a certain period of time, tE, the recipients cannot access the items (30) contained in the packaging containers until the predefined criteria are met and the recipients are authorised to access them.

The packaging system and method of the present invention can be implemented in various applications.

### Applications

There are several applications where an item (30) is delivered to a recipient but where the recipient cannot access it until the predefined criteria are met.

As discussed above, the invention is perfectly suited to the transport of radioisotopes from the place of production to different recipients, but only giving access to the radioisotope after the successful completion of quality tests by sending the authorisation code. By extension, the item (30) may be any chemical, food or other product with limited shelf life, the use of which is subject to prior authorisation by an authority separate from the recipient.

Article (30) may be the questions for a common examination or competition that must be distributed to the various centres where the examination will take place at a later date. To prevent any leakage of questions before the exam, the packaging system of the present invention is perfectly suited to guarantee the confidentiality of the questions. Thus, the packaging containers (1) can be delivered to the various centres at any time before the date of the exam. No one will be able to unlock the packaging containers (1) before receiving the authorisation code (23ID) sent by a central authority through the release centre (100) on the day of the test. This prevents the risk of cheating. The release centre is a processor, computer, smartphone or any other device configured, on the one hand,
to generate the authorisation code (23ID), preferably in the form of a QR code, but which may take other forms such as a barcode, and which lists the identification numbers (3ID) of the electronic locks (3) on the packaging crates that can be opened once the key has been authorised, and, on the other hand,
to send the authorisation code (23ID) to the recipient.

Ballot containers filled with ballot papers, either for storage until the last day of voting in the case of voting spread over more than one day, or when transporting ballot containers from different polling stations to a counting centre in order to protect them until counting begins. The packing cases containing the ballot containers may only be opened by authorised persons once all the ballot containers have arrived and the authorisation code has been sent by a central authority via the release centre (100).

A company that exports products abroad can provide an electronic key (3) and an authorisation device (10) to the customs authorities of the countries of the sender and recipients. Valuable items can thus be shipped in locked packaging crates while allowing access to the items (30) to customs officers who wish to inspect them by sending them, upon request, the identification numbers (3ID) of the packaging crates (1) they wish to inspect and receiving in return an authorisation code (23ID) to unlock them.

### Method Applied to the Transport of Radioisotopes

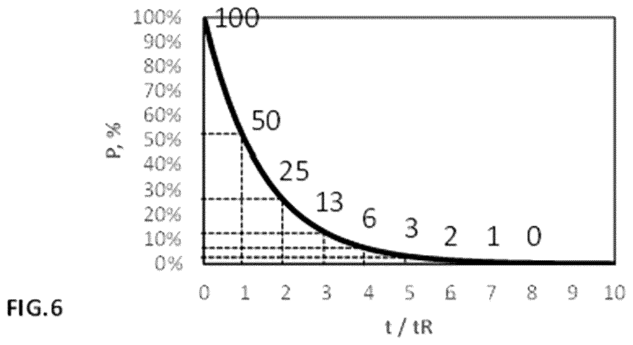

As discussed, the packaging system of the present invention is particularly suitable for the transport of radioisotopes, which combine, on the one hand,
limited stability over time, characterised by their half-life, tR, which controls the rate of degradation of their population, P(t), exponentially according to P(t)=exp(ln(2) t/TR) (see FIG. 6) and which encourages their use as quickly as possible, and, on the other hand,
the imposition of quality standards that take some time to verify through quality tests and that require the use of radioisotopes to be delayed until positive results are obtained in the quality tests.

In the absence of a lock on the packaging container, there have been cases—fortunately very rare—where the recipient, torn between these two opposing constraints, has decided to use the radioisotope before receiving authorisation, which is only granted if the quality tests are positive. The packaging system of the present invention allows the radioisotope to be locked in the packaging container and only allows the recipient to access the radioisotope after a positive result in the quality tests, using the electronic key that has been given authorised key status (12a) to unlock the packaging case by means of the authorisation device (10) using the authorisation code (23ID).

In the case of radioisotope transport, the packaging case (3) preferably meets the criteria for a Type A package. For example, as illustrated in FIGS. 1a, 1b, 3b and 3c, the radioisotope may be contained in a vial (30f) which is placed in a shielded container (5) whose walls are configured to absorb part of the radioactivity emitted by the radioisotope. The walls may comprise lead or any other material characterised by high absorbance of radioactive radiation.

Thus, the method applied to the transport of radioisotopes comprises the steps illustrated in FIGS. 4a and 4b.

As illustrated in step (A) of FIGS. 4a and 4b, a producer produces the radioisotope and encloses the radioisotope in vials (30f). This step takes a time, tA. The radioisotope may have a half-life, tR, preferably less than 24 hours, preferably no more than 14 hours, preferably no more than 6 hours, and even more preferably, no more than 2 hours. For example, the radioisotope may be selected from ¹³N with a half-life of 10 minutes, or ¹¹C with a half-life of 20 min, ⁶⁸Ga with a half-life of 68 min, or ¹⁸F with a half-life of 110 min, or ^{99m}Tc with a half-life of 6 h, or ¹²³I with a half-life of 13.2 h.

Step (B) in FIGS. 4a and 4b shows that the producer analyses the radioisotope produced to determine whether it complies with the radioisotope quality criteria defining the predefined criteria. This step (B) takes a time, tB, which is not negligible and cannot be reduced. The time, tB, must be as short as possible to allow the recipient to access the radioisotope before its population is significantly reduced. For example, a ratio, tB/tR, of the time, tB, required to complete the quality tests on the half-life (tR) of the radioisotope is preferably less than 2 (i.e., tB/tR<2) corresponding to an available population of 25% of the initial population, preferably less than 1 (i.e., tB/tR<1), corresponding to an available population of 50% of the initial population, and preferably less than 0.5 (i.e., tB/tR<0.5), corresponding to an available population of 70% of the initial population. However, the time, tB, to complete the quality tests cannot be reduced indefinitely and generally takes longer than the time, tC, required to package the radioisotope in the packaging container and is often longer than the time, tC+tD, required to package the radioisotope (step C described below) and deliver it to one or more recipients (step D described below) (i.e. tB>(tC+tD)), leaving the locked packaging containers (1) stored at one or more recipients for a period of time, tE, until the authorisation code (23ID) is received (see step (E) in FIGS. 4a and 4b).

Step (C) in FIGS. 4a and 4b illustrates the sender packing each vial (30f) in a packaging container (1). Preferably, the vials (30f) are placed in shielded packaging (5) before being inserted into the packaging container. The shipper locks the electronic lock (3) with the lid (1c) in the closed position. Preferably, the electronic lock (3) locks automatically when the lid is moved from the open position to the closed position and does not require a key to lock it.

Step (D) in FIGS. 4a and 4b illustrates the shipment and delivery of the packaging containers (1) to one or more recipients. Each recipient has at least one unauthorised electronic key (12n) and an authorisation device (10) configured to authorise the electronic key to unlock the electronic locks (3) whose identification number (3ID) is contained in the authorisation code (23ID).

As illustrated in step (E) of FIGS. 4a and 4b, while awaiting the results of the quality tests, the recipient(s) store the packaging crates (1), which cannot be opened without the corresponding authorisation codes that allow unauthorised keys (12n) to be changed to authorised keys (12a) that can open them. The storage time, tE, is the difference between the time, tB, required to complete the quality tests and the time (tC+tD) required for packaging and transport, i.e., tE=tB−(tC+tD). During the entire storage time, tE, the recipient cannot access the radioisotope contained in the packaging crate(s) (1).

Step (F) in FIGS. 4a and 4b shows that once the radioisotope analyses are complete and the radioisotope is deemed to meet the predefined quality criteria, the producer generates, through the release centre (100), an authorisation code (23ID) comprising the identification numbers (3ID) of the electronic locks (3) of the crates sent to each recipient and sends them to the corresponding recipients. The authorisation code (31D) may be a QR code, a barcode or an alphanumeric code. Preferably, the authorisation code is a QR code.

In step (G) of FIGS. 4a and 4b, each recipient changes the status of their electronic key from unauthorised key (12n) to authorised key (12a) by reading the authorisation code (23ID) they have received using their authorisation device (10), for the electronic locks that correspond to them and are contained in the authorisation code (23ID). By reading the authorisation code (23ID), preferably the QR code, the reader (10L) makes it possible to identify, without any risk of human transcription error, the identification numbers of all the electronic locks that the electronic key will be authorised to unlock. As illustrated in step (H) of FIGS. 4a and 4b, each recipient can unlock the packaging containers (1) they have received with the authorised key (12a) and can access the radioisotope (30) that is certified to meet the quality criteria.

As illustrated in steps (I) and (J) of FIG. 4b, if the predefined criteria are not met, the sender or third party informs the recipients that the radioisotope does not meet the required quality criteria. They therefore do not send the authorisation code (23ID) and inform each recipient that the corresponding packaging crates (1) will be taken back by the sender or third party.

The packaging system and method of the present invention thus make it possible to considerably reduce the risk of unauthorised opening of the packaging containers (1) and at the same time to reduce the time, t4, taken to open the packaging containers to the minimum time, tB, required for quality testing (i.e., t4=tB). The alternative to prevent unauthorised opening would be to wait for the results of the quality tests before shipping the packaging containers, extending the time t4 to t4=tB+tD, compared to the present invention in which t4=tB. For example, if the radioisotope is ¹⁸F with a half-life of tR=110 min and the quality tests and transport each take a certain amount of time, tB=tD=55 min, the time t4 at which the recipient has access to the radioisotope increases from t4=tB=55 min according to the invention to t4=tB+tD=55+55 min=110 min. The population of ¹⁸F after a time t4=55 min is 70% of the initial population with the invention, whereas after a time t4=110 min, the population of ¹⁸F has been reduced to only 50% of the initial population.

### Method Applied to the Transport of Confidential Items Until a Given Date

FIG. 5 illustrates, on a timeline equivalent to that of FIG. 4a discussed above for radioisotopes, the case where the predefined criterion is a date before which access to the item (30) contained in the packaging containers (1) is prohibited to recipients. This applies, for example, to exam or competition questions distributed to the various exam centres before the date of the exam and which must remain confidential until the date of the exam. It also applies to ballot papers that must remain confidential until a counting office is ready to begin counting, either for an election spread over several days or simply during the transfer of ballot papers from the various polling stations to the counting centre(s).

As illustrated in step (C) of FIGS. 5a and 5b, the examination questions or ballot papers or any other relevant items are packed in packing cases (1). The packing cases (1) are transported in step (D) to the various recipients (e.g., examination centres or counting offices) where they are stored in step (E) for a period of time, tE, during which the recipients are not allowed to access the items (30).

On the scheduled date of the examination or counting (or other), an authorisation code (23ID) is sent by the release centre (100) at stage (F) to the recipients by an authorised entity. The recipients can then authorise the electronic keys in their possession to unlock the electronic locks ( ) whose identification numbers (3ID) are contained in the authorisation codes that each recipient has received (see step (G)). The packaging containers (1) can therefore be unlocked by the corresponding authorised electronic keys (12n) by the recipients in step (H). The examination questions can then be distributed to the candidates without risk of leakage, or the ballot papers can be counted without risk of fraud.

The present invention is suitable for this type of application, allowing items (30) to be stored at the recipients' premises while prohibiting access to the items by the recipients until the date or time defined for making the items available to the recipients. The confidentiality of documents such as examination questions or ballot papers is guaranteed until the date scheduled for their disclosure.

| # | Feature |
|---|---|
| 1 | Packaging container |
| 1c | Packaging cavity |
| 1f | Cavity filling, e.g. foam |
| 1L | Packaging lid |
| 3 | Electronic lock |
| 3ID | Electronic lock identification number |
| 5 | Container |
| 10 | Authorisation device |
| 10i | Interface between the authorisation device and the electronic key |
| 12a | Electronic key authorised to unlock an electronic lock |
| 12n | Electronic key not authorised to unlock an electronic lock |
| 13ID | QR code or barcode reader |
| 23ID | Authorisation code |
| 30 | Item |
| 30f | Vial |
| tA | Production time for the item |
| tB | Radioisotope quality testing time |
| tC | Item packaging time |
| tD | Item transport time |
| tE | Storage time of the packaging crate at the recipient's premises |
| | before opening |
| tEx | Date of authorisation to access items (e.g., examination questions, |
| | ballot papers) |

1. A system for packaging an item (30) comprising,
a packaging container (1) configured to contain an item (30) in a cavity (1c) and comprising a lid (1L) configured to move between an open position providing access to the cavity (1c) and a closed position preventing access to the cavity, the packaging container being equipped with an electronic lock (3) comprising an identification number (3ID) and configured to lock the lid in the closed position and to allow it to be unlocked only by means of an authorised physical electronic key (12a) to unlock it,
the electronic key is by default in an unauthorised key status that is not authorised to unlock any electronic lock (3) and the electronic key is configured to switch,
from the default unauthorised key status (12n), in which the unauthorised key cannot unlock the electronic locks
to an authorised key status (12a) in which the authorised key (12a) is able to unlock the electronic locks (3) for which it has received authorisation according to the identification number (3ID).
an authorisation device (10) comprising a reader (13ID) configured to read an authorisation code (23ID) associated with one or more identification numbers (3ID) of electronic locks (3), the device being configured to change the status of an electronic key from the unauthorised key status (12n) to the authorised key status (12a), authorising the authorised electronic key (12a) to unlock one or more electronic locks (3) whose identification number(s) (3ID) are included in the authorisation code (23ID).

2. A release centre (100) configured to generate and remotely send the authorisation code (23ID) comprising a list of one or more packaging containers to a recipient in possession of the one or more packaging containers (1), of the authorisation device (10), and of the electronic key (3), only after predefined criteria have been met, which are independent of the recipient(s) and necessary for authorising the opening of the one or more packaging containers by the authorised electronic key.

3. The packaging system according to claim 1, adapted for transporting the item (30) including of a radioisotope having a half-life, the packaging system comprising:
a vial (30f) configured to enclose the radioisotope; and
a shielded container (5) configured to enclose the vial enclosing the radioisotope and to be enclosed within the cavity (1c) of the packaging case (1).

4. The packaging system according to claim 2, wherein the packaging is a Type A package.

5. The packaging system according to claim 1, in which the authorisation code (31D) is a QR code or a barcode or an alphanumeric code and in which the reader (13ID) is a QR code or barcode reader or an interface for entering the alphanumeric code.

6. A method for preventing the opening of a packaging crate (1) containing an item (30) without first receiving authorisation, which is issued according to predefined criteria, the method comprising the use of a packaging system according claim 1 in the following manner:
(A) a sender packs each item (30) in a packaging container (1) and locks the electronic lock (3) with the lid (1c) in the closed position,
(B) the packaging containers (1) are delivered to one or more recipients, each recipient having an authorisation device (10) and at least one unauthorised electronic key (12n),
(C) as long as predefined criteria independent of the recipient(s) and necessary for authorising the opening of one or more packaging containers are not met, the corresponding electronic key(s) (3) remain in the unauthorised key status and the packaging container(es) (1) cannot be opened by the corresponding recipient(s),
(D) once the predefined criteria are met, the release centre (100) generates an authorisation code (23ID) comprising the identification numbers (3ID) of the electronic locks (3) of the containers sent to each recipient and sends them to the corresponding recipients,
(E) using their authorisation device (10), each recipient changes the status of their electronic key from unauthorised key (12n) to authorised key (12a) for the electronic locks that correspond to them and are contained in the authorisation code (23ID) they have received, and
(F) each recipient can unlock the electronic lock on the packaging containers (1) they have received using their authorised key (12a) and can access the item (30) that meets the predefined criteria.

7. The method according to claim 6, wherein the item (30) is a radioisotope with a half-life, the method comprising:
a producer produces the radioisotope and encloses the radioisotope in vials (30f),
the producer analyses the produced radioisotope to determine whether it complies with radioisotope quality criteria defining the predefined criteria,
the shipper packages each vial (30f) in a packaging case (1) and locks the electronic lock (3) with the lid (1c) in the closed position,
the packaging containers (1) are delivered to one or more recipients, each recipient having an authorisation device (10) and at least one unauthorised electronic key (12n),
the recipient(s) store the packaging containers (1), which cannot be opened without the corresponding authorisation codes that allow the unauthorised keys (12n) to be changed to authorised keys (12a) that can be used to open them,
once the radioisotope analyses have been completed and the radioisotope is considered to comply with the predefined quality criteria, the producer generates an authorisation code (23ID) comprising the identification numbers (3ID) of the electronic locks (3) of the containers sent to each recipient and sends them to the corresponding recipients,
using their authorisation device (10), each recipient changes the status of their electronic key from unauthorised key (12n) to authorised key (12a) for the electronic locks that correspond to them and are contained in the authorisation code (23ID) they have received, and
each recipient can unlock the packaging containers (1) they have received with the authorised key (12a) and can access the radioisotope (30) that is certified as complying with the quality criteria.

8. The method according to claim 7, wherein the vial (30f) is enclosed in a shielded container (5) which is itself enclosed in the packaging container (1).

9. The method according to claim 7, wherein a time (tB) required to complete the analyses of the radioisotope and determine whether the radioisotope complies with the radioisotope quality criteria is longer than a time tC required for packaging the radioisotope (step C) (i.e., tB>tC).

10. The method according to the previous claim 9, wherein the time (tB) required to complete the radioisotope analyses and determine whether the radioisotope complies with the radioisotope quality criteria is less than two half-lives, tR, of the radioisotope.

11. The method according to claim 7, wherein the half-life of the radioisotope (30) is no more than 14 hours.

12. The method according to claim 11, wherein the radioisotope is selected from ¹³N with a half-life of 10 min, or ¹¹C with a half-life of 20 min, ⁶⁸Ga with a half-life of 68 minutes, or ¹⁸F with a half-life of 110 minutes, or ^{99m}Tc with a half-life of 6 hours, or ¹²³I with a half-life of 13.2 hours.

13. The method according to claim 6, wherein
the item (30) is delivered to one or more recipients prior to payment for it, and the predefined criteria include receipt of payment for the item, or
the item (30) is a chemical product and the predefined criteria include compliance with quality criteria requiring analysis, or
the item (30) is a chemical product or a medicine whose use is subject to prior approval by a superior who is located far from the storage location of the package (1), or
the item (30) can only be accessed on a predefined date.

14. The method according to claim 6, wherein once authorised, the authorised electronic key (12a) automatically becomes unauthorised (12n) again after a predetermined time or after the corresponding electronic lock is unlocked.

15. The method according to claim 6, wherein if the predefined criteria are not met, the sender or third party does not send the authorisation code (23ID) and informs each recipient that the corresponding packaging crates (1) will be taken back by the sender or third party.

16. The packaging system according to claim 3, in which the authorisation code (31D) is a QR code or a barcode or an alphanumeric code and in which the reader (13ID) is a QR code or barcode reader or an interface for entering the alphanumeric code.

17. The method according to claim 7, wherein the radioisotope quality criteria is longer than a time tC is longer than the time (tC+tD) required to package the radioisotope (step C) and deliver it to one or more recipients (step D) (i.e. tB>(tC+tD)), leaving the packaging crates (t1) locked at one or more recipients for a period of time (tE=tB−(tC+tD)), until the authorisation code (23ID) is received.

18. The method according to the previous claim 10, wherein the radioisotope quality criteria is less than one half-life, tR, of the radioisotope (i.e., tB<2tR, preferably tB<tR).

19. The method according to claim 11, wherein the half-life of the radioisotope (30) is no more than 6 hours.

20. The method according to claim 11, wherein the half-life of the radioisotope (30) is no more than 2 hours.
